(19) United States
(12) Patent Application Publication
(10) Pub. No.: US 2015/0081188 A1
(43) Pub. Date: Mar. 19, 2015

(54) DRIVER ASSISTANCE SYSTEM FOR A MOTOR VEHICLE

(71) Applicant: Robert Kornhaas, Spraitbach (DE)

(72) Inventor: Robert Kornhaas, Spraitbach (DE)

(73) Assignee: ROBERT BOSCH GMBH, Stuttgart (DE)

(21) Appl. No.: 14/490,053

(22) Filed: Sep. 18, 2014

(30) Foreign Application Priority Data
Sep. 19, 2013 (DE) 10 2013 218 812.9

(51) Int. Cl. B60W 30/09; B60T 7/22; G01S 13/93

(52) U.S. Cl. CPC B60W 30/09; G01S 13/931; B60T 7/22
USPC 701/70; 701/1

(57) ABSTRACT

A driver assistance system for intervening in the control of at least one of a drive system, a controller, or signaling devices of a motor vehicle includes: a radar control unit having a radar sensor; and a mobile device having a video sensor for ascertaining surroundings information, the mobile device being a mobile phone or a smart phone, for example. In this case, the mobile device transmits the ascertained surroundings information to the radar control unit via a first wireless connection.

### BACKGROUND OF THE INVENTION

1. Field of the Invention

The present invention relates to a driver assistance system for a motor vehicle and a method for operating a driver assistance system for a motor vehicle.

2. Description of the Related Art

Motor vehicles are increasingly equipped with driver assistance systems which include, in particular, comfort-oriented driver assistance systems and electronically controllable braking assistance systems, in particular having an emergency braking assistance system.

The known driver assistance systems are generally activated and operated by the driver of the motor vehicle via corresponding operating elements or human machine interfaces (also referred to as HMI). In this case, systems are known such as the adaptive cruise control (ACC) which recognize preceding cars, adapt the distance and the velocity of the host vehicle, and in addition, implement a collision prevention or collision mitigation function in the form of an automatic braking action, if an imminent collision risk is recognized with the aid of the data of the surroundings sensors. However, there are safety requirements for these systems, which must be complied with and which are complex and cost-intensive due to the redundant sensor data to be used.

It is therefore an object of the present invention to provide a motor vehicle including a driver assistance system which is cost-effective, space-saving, and constructed in a simple manner.

### BRIEF SUMMARY OF THE INVENTION

A driver assistance system for intervening into a drive system, a controller or a signaling device of a motor vehicle including a radar control unit having a radar sensor and a mobile device having a video sensor for ascertaining surroundings information [are provided], the mobile device being a mobile phone or a smart phone including a camera system, for example. In this case, the mobile device transmits the ascertained surroundings information to the radar control unit via a first wireless connection.

The radar control unit is advantageously connected to an engine controller and an electronic stability program, the radar control unit being integrated inconspicuously into the front of the vehicle. In one preferred specific embodiment, the radar control unit has a sensor data fusion unit for processing the ascertained vehicle information and the surroundings information of the mobile device, so that the radar control unit detects the input signals, in particular the video sensor information data from the mobile device and the data of the radar sensor, and subsequently carries out an analytical redundancy check. For this purpose, the ascertained vehicle information and the surroundings information are processed according to an accident computation algorithm, so that a potentially critical traffic situation may be recognized based on the accident computation algorithm. Accordingly, control instructions are, for example, relayed to the drive system, the controller or the signaling devices based on this redundancy check, the image information from the video sensor of the mobile device confirming the measured data of the radar sensor of the radar control unit, so that the result of this redundancy check forms a piece of redundant information in the sense of the safety level SIL3 of the functional safety standard IEC 61508 (sensor fusion).

The sensor data fusion of the radar control unit represents a variant of information fusion, the information sources being in this case limited to sensors, i.e., measured variable sensors of the radar sensor and the mobile device or a video sensor of the built-in camera.

The transduction of the control instructions preferably takes place via at least one automobile bus system, e.g., CAN, LIN, MOST and/or FlexRay. While the MOST bus was designed, in particular, for multimedia applications, CAN busses having a bandwidth of <=1 Mbit/s and LIN busses having a bandwidth of 20 Kbit/s are used for controlling the vehicle electronics.

In contrast, FlexRay covers the other end of motor vehicle bus systems with the aid of its fast data rate of 10 Mbit/s. In principle, these bus systems enable the communication for controlling any type of system and moreover provide information to the dashboard, where the driver may read off data such as fuel level or engine temperature.

The first wireless connection advantageously has a gross data rate of at least 1 Mbit/s, preferably 2 Mbit/s, particularly preferably 3 Mbit/s. In this way, it may be ensured that the gross data rate of the connection between the mobile device and the radar control unit is sufficient for transferring 24 objects having 80 bits of data several times within 20 ms. For this purpose, it is particularly advantageous if the first connection between the radar control unit and the mobile device takes place via Bluetooth.

Particularly preferably, a head unit control unit is additionally provided, the head unit control unit being advantageously connected to the electronic stability program and the engine controller via the bus system.

Alternatively, in one particularly preferred specific embodiment, the head unit control unit may also be connected to the radar control unit, a second wireless connection, in particular via Bluetooth, being advantageously provided in this case. It is possible in this way that the radar control unit relays the control instructions to the head unit control unit via the second connection. Subsequently, the head unit control unit relays the control instructions to the electronic stability system and the engine controller via the bus system. The gross data rate between the radar control unit and the head unit control unit, which is necessary for the control instructions, generally ranges between 128 bit/10 ms and 250 bit/10 ms.

In one preferred specific embodiment, the radar control unit has at least one radar sensor as a short-range sensor and/or as a long-range sensor, in particular an LRR sensor, the distance (d) and the relative velocity (vrel) with regard to a preceding car being determined from the ascertained data of the radar sensor, thus making it possible to ascertain therefrom the time left before a collision. The radar sensor preferably detects preceding road users or objects up to a distance of 350 meters in an angular range of +/−45 degrees to the center line.

The vehicle surroundings are advantageously detected in an area in the direction of which the motor vehicle is travelling. The detection of the entire vehicle surroundings is in principle also conceivable, data of a mobile device which includes a camera and which is situated in the rear area of the motor vehicle being detected, for example. Here, the driver assistance system may usually evaluate information which is detected by one or multiple surroundings sensors with the aid of the radar control unit.

Accordingly, it is particularly advantageous if vehicle-internal information from sensors, in particular information from sensors of an ABS system, a TCS system, an electronic stability program, a chassis control system, a restraint system, an engine control system and/or another comfort system, is incorporated for ascertaining the vehicle information. These sensors may be, for example, radar sensors, optical cameras, ultrasonic sensors, lidar sensors, or infrared sensors which are differently well suited for each application. For example, lidar sensors are suitable for applications in the ACC system or in the traffic jam assist system, optical cameras or video cameras are suitable for traffic sign recognition systems and lane departure warning systems, radar sensors are suitable for blind spot detection systems and lane change assistant systems, and IR sensors are suitable for the night vision system; ultrasonic sensors are suitable for short-range and/or long-range infrared and for the Park Mate system, and optical cameras or radar sensors are, in turn, suitable for sensitive guidance.

Here, it is particularly advantageous if the first detection system for ascertaining the vehicle-internal information from these sensors, in particular information from sensors of an ABS system, a TCS system, an electronic stability program, a chassis control system, a restraint system, an engine control system and/or another comfort system, is incorporated. For example, the sensors of the electronic stability program, such as pressure sensors, steering wheel sensors, wheel sensors, yaw rate sensors, and transverse acceleration sensors, provide information regarding the direction of travel. Furthermore, additional vehicle-internal information may be retrieved from a control unit of the electronic stability program, for example, which is connected via a CAN bus system to the engine and an automatic transmission and thus receives the instantaneous data regarding the engine torque, the accelerator pedal position, and the gear ratio.

Furthermore, a method for operating a driver assistance system for intervening into a drive system, a controller, or a signaling device of a motor vehicle is provided in which a mobile device is mounted on the motor vehicle. The mobile device has a video sensor for ascertaining surroundings information. In a first method step, a first wireless connection between the mobile device and a radar control unit is established. In a second method step, a calibration subsequently takes place between the mobile device and the radar control unit, in a third method step, data being detected from the vehicle surroundings via the video sensor of the mobile device and the radar sensor of the radar control unit. Subsequently, the detected data of the mobile device are transmitted to the radar control unit via a first wireless connection; the radar control unit fuses the detected and transmitted data according to an accident computation algorithm and relays control instructions to the drive system, the controller and/or the signaling devices of the motor vehicle via the radar control unit in order to initiate an autonomous braking action in the event of a recognized critical traffic situation.

Advantageously, the radar control unit additionally receives and fuses vehicle-internal information, in particular information from sensors of an ABS system, a TCS system, an electronic stability program, a chassis control system, a restraint system, an engine control system and/or another comfort system and/or vehicle-internal information of other road users which are present in the surroundings of the motor vehicle from vehicle-to-vehicle communication interfaces and/or from vehicle-to-x communication interfaces.

In another specific embodiment, acoustic and/or visual warning signals are emitted in the event of a recognized critical traffic situation, the hazard warning lights and/or the high beam of the motor vehicle being provided for emitting visual signals and/or the horn of the motor vehicle being provided for emitting acoustic signals.

Depending on the situation, a collision with other road users and/or objects may be avoided or its consequences may be considerably reduced with the aid of the present driver assistance system according to the present invention or with the aid of a method according to the present invention.

Other features, possible applications, and advantages of the present invention are derived from the following description of the exemplary embodiment of the present invention, which is illustrated in the figures.

### BRIEF DESCRIPTION OF THE DRAWINGS

FIG. 1 schematically shows a first specific embodiment of a driver assistance system according to the present invention.

FIG. 2 schematically shows a second specific embodiment of a driver assistance system according to the present invention.

### DETAILED DESCRIPTION OF THE INVENTION

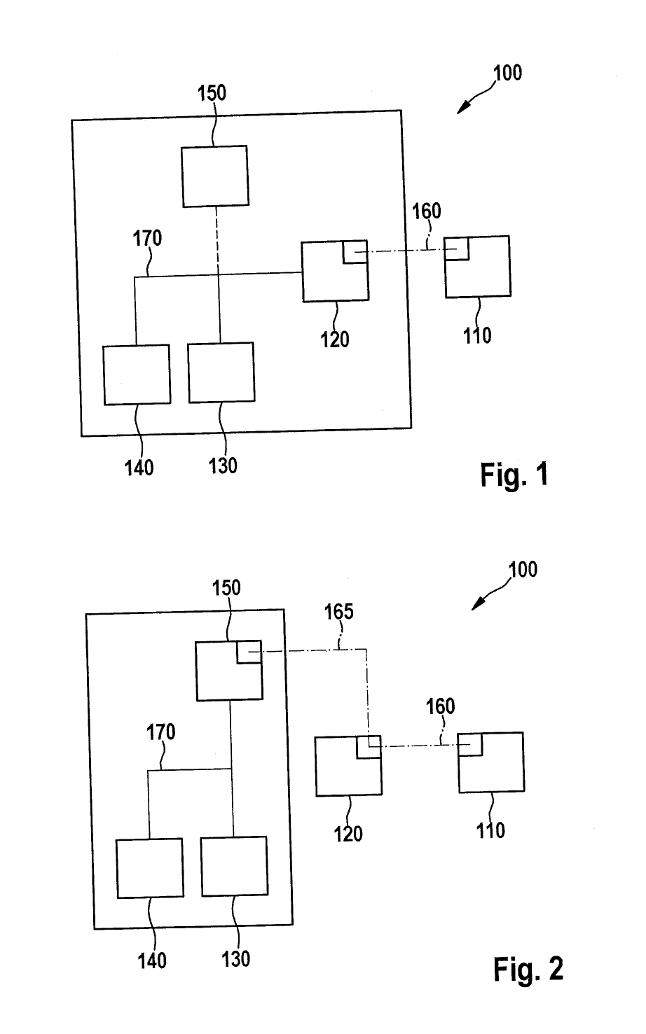

A first variant of a driver assistance system 100 for a motor vehicle according to the present invention is schematically illustrated in FIG. 1. Driver assistance system 100 includes a mobile device 110 for ascertaining surroundings information of the motor vehicle, mobile device 110 having a camera system including a video sensor and being a mobile phone or a smart phone, for example. Mobile device 110 is connected to a radar control unit 120 via a first wireless connection 160, in particular via a Bluetooth connection, radar control unit 120 receiving data of a radar sensor. After mounting mobile device 110 and after successfully establishing first connection 160, a calibration is carried out between mobile device 110 and radar control unit 120.

The specific embodiment illustrated in FIG. 1 is also provided with a head unit control unit 150, the presence of head unit control unit 150 not being absolutely necessary. Head unit control unit 150 is advantageously connected via a bus system 170 to an electronic stability program 130, an engine controller 140, and radar control unit 120. For this purpose, first connection 160 between mobile device 110 and radar control unit 120 advantageously has a gross data rate of at least 1 Mbit/s, preferably 2 Mbit/s, particularly preferably 3 Mbit/s, thus ensuring that the gross data rate of connection 160 between mobile device 110 and radar control unit 120 is sufficient for transferring 24 objects having 80 bits of data within 20 ms.

In principle, a possible bidirectional communication is provided between mobile device 110, radar control unit 120, electronic stability program 130, and engine controller 140. In this way, radar control unit 120 may receive the input signals, in particular the sensor information data from mobile device 110 and electronic stability program 130; subsequently, radar control unit 120 carries out an analytical redundancy check and, for example, sends the control instructions back to electronic stability program 130 and/or engine controller 140. Here, the image information from a video sensor of the camera system of mobile device 110 confirms the measured data of the radar sensor of radar control unit 120 or a radar sensor of electronic stability program 130, so that this information forms a piece of redundant information in the sense of the safety level SIL3 of the functional safety standard IEC 61508 (sensor fusion).

The transduction of the control instructions to electronic stability program 130 and engine controller 140 preferably takes place via bus system 170, e.g., CAN, LIN, MOST and/or FlexRay. While the MOST bus was designed, in particular, for multimedia applications, CAN busses having a bandwidth of <=1 Mbit/s and LIN busses having a bandwidth of 20 Kbit/s are used for controlling the vehicle electronics. In contrast, FlexRay has a data rate of 10 Mbit/s. In principle, these bus systems enable the communication for controlling any type of driver assistance systems and moreover provide information to the dashboard, where the driver may read off data such as fuel level or engine temperature.

If the analytical redundancy check was completed successfully by radar control unit 120, these checked pieces of sensor information are considered to be redundant and safe so that they form pieces of redundant information in the sense of the safety level SIL3 of the functional safety standard IEC 61508. These pieces of information may then advantageously be checked for plausibility by radar control unit 120 in such a way that a corresponding identification may be added to the sensor data. The pieces of information checked for plausibility are generally made available to a braking assistance system which initiates an automatic emergency braking action, known per se, based on these pieces of information if the sensor information of the surroundings sensors as well as, if applicable, additional sensor information, which was checked for plausibility by radar control unit 120, indicate a hazardous situation requiring an emergency braking action. Since the emergency braking action takes place on the basis of sensor information which was checked for plausibility and which corresponds to the above-mentioned safety level SIL3 of the standard IEC 61508, the emergency braking action does neither have to be actively confirmed by the driver nor does a limitation of the braking duration or braking intensity necessarily take place by driver assistance system 100. Accordingly, road safety is increased overall by provided driver assistance system 100 according to the present invention and by a method according to the present invention, since severely hazardous situations, in particular, which may be undoubtedly recognized with the aid of the sensor system, may be countered in a positive manner.

The specific embodiment illustrated in FIG. 2 differs from the specific embodiment illustrated in FIG. 1, inter alia, in that there is a second wireless connection, preferably a Bluetooth connection, between head unit control unit 150 and radar control unit 120. It is possible in this constellation that radar control unit 120 relays the control instructions directly wirelessly to head unit control unit 150, whereby an additional wired connection between radar control unit 120 and head unit control unit 150 may be saved. Head unit control unit 150 subsequently relays the appropriate control instructions via bus system 170 to electronic stability program 130 and engine controller 140. The gross data rate, which is necessary for the control instructions, between radar control unit 120 and head unit control unit 150 generally ranges between 128 bit/10 ms and 250 bit/10 ms and thus significantly below the necessary gross data rate of first connection 160.

Radar control unit 120 may include a sensor data fusion unit, among other things, and be integrated inconspicuously into the front of the vehicle. The sensor data fusion of radar control unit 120 represents a variant of information fusion, the information sources being limited to sensors in this case, i.e., measured variable sensors of mobile device 110, a video sensor of the integrated camera system, and the radar sensor of the radar control unit or electronic stability program 130, these sensors detecting the surroundings of the motor vehicle in each of their delimited detection areas, so that these surroundings sensors make it possible for driver assistance system 100 to actively assist the driver of the motor vehicle.

Radar sensors are used, for example, to detect the distance from preceding vehicles. The video sensors of mobile device 110 may be used for lane recognition, a light detection during darkness, a traffic sign recognition, or a vehicle detection. Furthermore, driver assistance system 100 may be equipped with other surroundings sensors, which are not illustrated here in greater detail, for the purpose of detecting the vehicle surroundings; these surroundings sensors may, for example, be sensors from assistance systems such as the anti-lock system (ABS), the traction control system (TCS), the autonomous braking action (emergency braking system in the event of health-related problems of the driver), the electronic stability program (ESP), the traction control system (TCS), the engine drag torque control, the electronic differential lock (EDL), the automatic lighting system, the adaptive curve light, the adaptive high beam assistant, the night vision assistant, the automatic wiper, the head-up display (HUD), the brake assist system (BAS), the automatic emergency braking (AEB), the hill hold control, the hill descent control, the speed control (system for automatically controlling speed), the adaptive cruise control (ACC), the distance warning system, the blind spot detection system, the congestion assistant, the lane recognition system, the lane keeping assistant/lane assistant (including transverse guidance assistance functions such as lane departure warning, lane keeping support, lane change assistance, lane change support), intelligent speed adaptation (ISA), the vehicle-to-vehicle communication, the tire pressure control system, the park distance control (using ultrasonic sensors for recognizing obstacles and distances), the driver drowsiness detection, and the traffic sign recognition. In order to also check these obtained pieces of sensor information, the ascertained data are transferred to radar control unit 120 and fused there accordingly.

Within the scope of the present invention, electronic data transmission systems which transmit sensor information of adjacent vehicles (vehicle-to-vehicle communication interfaces) and sensor information between vehicles and their surroundings (vehicle-to-x communication interfaces) are also understood to mean surroundings sensors. Applications which are primarily based on these pieces of information are, for example, local hazard warnings, traffic light phase assistants (green light optimal speed advisory), or warnings of rescue vehicles. Furthermore, the above-named systems may be expanded by map information or be based on this information. Examples include navigation systems, traffic sign recognition systems, or curve warning assistants.

These obtained pieces of sensor information are also evaluated and fused in a sensor data fusion unit with the aid of radar control unit 120. The sensor data fusion unit is configured to check the non-redundant sensor information of the detected and ascertained data with the aid of analytical redundancies of different pieces of sensor information. The pieces of sensor information which are used for the logic check may be pieces of sensor information of other, connected surroundings sensors. Furthermore, sensors may be directly connected to radar control unit 120 and may either be used as pieces of additional information for the analytical redundancies or checked themselves. The direct integration of sensors into radar control unit 120 furthermore has the advantage that costs may be saved as compared to the use of separate sensors in the related art.

The present invention is not limited to the exemplary embodiments described above, but also includes other specific embodiments of identical functionality. The description of the figures is only used to explain the present invention.

What is claimed is:

1. A driver assistance system for intervening in the control of at least one of a drive system, a controller and signaling devices of a motor vehicle, comprising:
a radar control unit having a radar sensor; and
a mobile device having a video sensor ascertaining surroundings information, wherein the mobile device transmits the ascertained surroundings information to the radar control unit via a first wireless connection.

2. The driver assistance system as recited in claim 1, wherein the radar control unit is connected to at least one of an engine controller and an electronic stability program.

3. The driver assistance system as recited in claim 2, wherein the radar control unit has a sensor data fusion unit for processing vehicle information and the ascertained surroundings information of the mobile device.

4. The driver assistance system as recited in claim 3, wherein the connection between the radar control unit and the mobile device takes place via Bluetooth.

5. The driver assistance system as recited in claim 3, wherein the first wireless connection enables a gross data rate of at least 1 Mbit/s.

6. The driver assistance system as recited in claim 3, further comprising:
a head unit control unit connected to at least one of the electronic stability program and the engine controller.

7. The driver assistance system as recited in claim 6, wherein the head unit control unit is connected to the radar control unit via a second wireless connection.

8. The driver assistance system as recited in claim 7, wherein the second connection between the radar control unit and the head unit control unit takes place via Bluetooth.

9. The driver assistance system as recited in claim 7, wherein vehicle-internal information from sensors of at least one of an ABS system, a TCS system, an electronic stability program, a chassis control system, a restraint system, and an engine control system is incorporated for ascertaining the vehicle information.

10. A method for operating a driver assistance system for intervening in the control of at least one of a drive system, a controller and signaling devices of a motor vehicle, the driver assistance system including a radar control unit having a radar sensor, and a mobile device having a video sensor, the method comprising:
mounting the mobile device on the motor vehicle;
establishing a first wireless connection between the mobile device and a radar control unit;
carrying out a calibration between the mobile device and the radar control unit;
detecting data regarding the vehicle surroundings of the motor vehicle via the video sensor of the mobile device;
ascertaining, by the radar control unit, data regarding vehicle information of the motor vehicle;
transmitting the detected data regarding the vehicle surroundings of the motor vehicle to the radar control unit via the first wireless connection;
fusing, by the radar control unit, the data regarding vehicle information and the data regarding the vehicle surroundings according to an accident computation algorithm;
relaying, with the aid of the radar control unit, the control instructions to at least one of the drive system, the controller and the signaling devices of the motor vehicle; and
initiating an autonomous braking action in the event of a recognized critical traffic situation.

11. The method as recited in claim 10, wherein the radar control unit additionally receives and fuses vehicle-internal information from sensors of at least one of an ABS system, a TCS system, an electronic stability program, a chassis control system, a restraint system, and an engine control system.

12. The method as recited in claim 11, wherein the radar control unit additionally receives and fuses vehicle-external information of other road users which are present in the surroundings of the motor vehicle from at least one of vehicle-to-vehicle communication interfaces and vehicle-to-x communication interfaces.
